(19) United States
(12) Patent Application Publication
(10) Pub. No.: US 2009/0070746 A1
(43) Pub. Date: Mar. 12, 2009

(54) METHOD FOR TEST SUITE REDUCTION THROUGH SYSTEM CALL COVERAGE CRITERION

(76) Inventors: Dinakar Dhurjati, Sunnyvale, CA (US); Ajay Chander, San Francisco, CA (US); Hiroshi Inamura, Cupertino, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/204,654

(22) Filed: Sep. 4, 2008

Related U.S. Application Data
(60) Provisional application No. 60/970,831, filed on Sep. 7, 2007.

(51) Int. Cl. G06F 11/36

(52) U.S. Cl. 717/128; 717/124; 717/131

(57) ABSTRACT

A method and apparatus is disclosed herein for determining whether a test case is to be included in a test suite. In one embodiment, the method comprises executing an application with test inputs of a test case during performance of software application testing and using a Finite State Machine (FSM) model of observable events generated from execution of other test cases in the test suite to determine whether to include the test case in the test suite for use in future testing of the application.

### PRIORITY

The present patent application claims priority to and incorporates by reference the corresponding provisional patent application Ser. No. 60/970,831, titled, “Method for Better Test Suite Reduction Through System Call Coverage Criterion,” filed on Sep. 7, 2007.

### FIELD OF THE INVENTION

The present invention is related to the field of reducing test suites in software testing; more particularly, the present invention is related to using a coverage criterion, which is based on observable events to reduce the number of test cases in a test suite.

### BACKGROUND OF THE INVENTION

Software testing is responsible for detecting faults early in development cycle and consumes a very significant portion of the software development resources. A large amount of resources in software development is spent on validating and testing software. Software developers and testers generate a large number of test cases either manually or using random testing or other systematic exploration techniques. As more and more test cases are added at various points of software development life cycle, the size of test suites may grow significantly.

Reducing or prioritizing test suites is often necessary to make the best use of testing resources. Test suite reduction is a part of software maintenance activity that helps in making better use of testing resources by focusing on important test cases that reveal faults rather than all the test cases. A large test suite is pruned to a smaller test suite so developers can use the smaller test suite more frequently to test their frequent updates to software (called smoke tests) while a larger test suite with all the test cases is run weekly or fortnightly (called nightly testing), thus improving the productivity.

Test suite reduction is typically done using some coverage criterion. In the testing world, coverage criteria are typically used as a quantitative metric to measure the amount of testing that is being performed and also to guide the testing process. Coverage criterion is usually defined in terms of an artifact of the source code. For example, statement coverage requires that each statement in the application under test be covered (or exercised) by at least one test case in the test suite. An application is supposed to 100% covered according to a criterion if the test suite is complete with respect to the criterion. Another example of coverage criterion is the edge coverage criterion. In this case, each edge in the control flow graph of the application source is required to be exercised by at least one test case in the test suite.

While coverage criteria are generally used to guide test case generation, they also are used in the dual problem of test suite reduction. Often, test cases are not generated according to any coverage criteria. For example, many test cases are added when bugs are identified and fixed. Also the entire test suite might have been generated randomly. Even when a coverage criterion is used, it might generate unmanageable number of test cases (path coverage). In each of these cases, a test suite might need reduction or prioritization.

Test suite reduction focuses on reducing the given test suite according to a coverage criterion. For example, reducing a test suite according to the statement coverage criterion would imply eliminating test cases that exercise statements that are already exercised by other test cases in the test suite. Since this process starts from an existing test suite, this may not generate a test suite that is complete with respect to the coverage criterion. If the test suite is already generated using a coverage criterion, then test suite reduction can be performed using another coverage criterion that might lead to smaller number of test cases.

Test suite reduction techniques can be classified into two different types. The first type of test suite reduction technique requires source code and/or performs a heavy instrumentation of source code. The second type of test suite reduction techniques works directly on the binaries and requires little or no instrumentation.

There are several of the previous approaches for test suite minimization that made heavy use of source instrumentation. One previous approach uses all-uses-coverage criterion to minimize test suites. All-uses coverage criterion requires each variable definition in the program and all its uses to be covered by at least one test case in the test suite. By using all uses coverage criterion, there is little reduction in fault detection capability. However, keeping track of variable definitions and their uses requires heavy instrumentation of source code.

In another approach, edge-coverage criterion is used as the criterion to minimize the test cases. This criterion requires that all the edges in the control flow graph of the application under test must be covered by at least one test case. By using edge coverage criterion, the reduction in test suite size was offset by significant reduction in fault detection capability. However, this technique requires instrumenting the source code to record each control flow edge when it is taken.

Another approach uses dynamic in variants observed through program execution (referred to as operational abstraction) to minimize test suites. For each test, the operational abstraction and check are computed to see if it changes the current operational abstraction. If it does, then the current operational abstraction is updated with the new information and the test is kept in the minimized test suite. Otherwise, if it does not change the current operational abstraction, then the test case is discarded. The invariants in this approach are on program variables and their relationships to other variables or constants. Computing these invariants requires instrumentation on most program variables and their uses. Consequently this approach is slow.

Other test suite reduction techniques work on binaries. One such approach was a call stack based test suite reduction approach that works directly on the binaries and does not require the source of the application under testing. A call stack by definition is the sequence of function calls on the stack at any point in the program execution. This approach uses the set of maximum depth call stacks (call stacks observed for leaf functions that do not call any other function) generated by a test case as the coverage criterion for suite reduction. If the set of maximum depth call stacks generated by a test case is a subset of maximum depth call stacks generated by previous test cases, then the test case is considered redundant and discarded.

### SUMMARY OF THE INVENTION

A method and apparatus is disclosed herein for determining whether a test case is to be included in a test suite. In one embodiment, the method comprises executing an application with test inputs of a test case during performance of software application testing and using a Finite State Machine (FSM) model of observable events generated from execution of other test cases in the test suite to determine whether to include the test case in the test suite for use in future testing of the application.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a flow diagram of one embodiment of a test suite reduction process.

FIG. 2 is a flow diagram of another embodiment of a test suite reduction process.

FIG. 3 illustrates a code snippet.

FIG. 4 illustrates a system call Finite State Machine (FSM) model constructed for the example snippet of FIG. 3 running on test inputs.

FIG. 5 is a block diagram of a software testing environment.

FIG. 6 is a block diagram of one embodiment of a computer system.

### DETAILED DESCRIPTION OF THE PRESENT INVENTION

A method and apparatus for reducing software test suites are disclosed. In one embodiment, the software test suites are reduced without losing much of the ability to detect faults. In one embodiment, externally observable events (e.g., system calls) are tracked to control the process of reducing the software test suites without requiring the source nor any instrumentation. In one embodiment, system call traces made by an application without requiring any instrumentation are used to measure the coverage of the program under testing. The system calls accurately model the application behavior for input/output intensive applications.

In one embodiment, the test suite reduction techniques described herein include building a model of the application under test by observing system call sequences. Test cases that do not update the constructed system call model are considered redundant and eliminated. Several existing models of system calls can be used for test suite reduction effectively. In one embodiment, a finite state machine (FSM) model is used with program counter as the state and the system calls as the transitions.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

To perform test suite reduction, one embodiment of the present invention obtains system call traces from a program's execution when run on a test case and uses them later for test suite reduction. For example, if a program when run on a test case generates artifacts that are all previously observed, then the test case is considered redundant. System call traces are used as an accurate set of artifacts for test suite reduction because the input/output (I/O) operations in any application are done via system calls. Thus, capturing system call traces provides a good approximation of the program's I/O behavior. In one embodiment, the computational aspects of the program are not captured by system calls alone.

At times, using system call traces from an application directly may not yield much benefit. For example, if a test case invokes a loop with a system call n times and another test case invokes the same loop n+1 times, system call traces for the two test cases would be different and no reduction is possible. Furthermore, because of loops in programs, system call traces are often long and can lead to unmanageable amounts of data for processing. Therefore, in one embodiment, a model was used to categorize system call traces. In one embodiment, a Finite State Machine (FSM) model is used. In one embodiment, the FSM model that is used is described in Sekar, et al., “A Fast Automaton-based Method for Detecting Anomalous Program Behaviours, Proceedings of the 2001 IEEE Symposium on Security and Privacy, 2001, pg. 144-155. However, other approaches for modeling system calls can also be used.

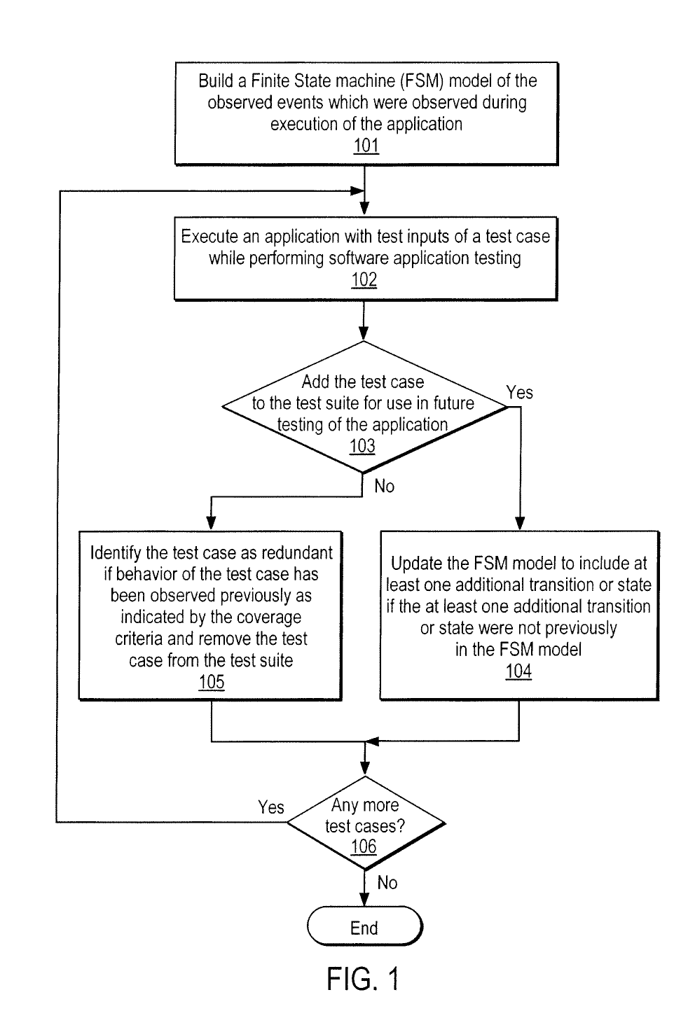

FIG. 1 is a flow diagram of one embodiment of a test suite reduction process. The process is performed by processing logic that may comprise hardware (circuitry, dedicated logic, etc.), software (such as is run on a general purpose computer system or a dedicated machine), or a combination of both.

Referring to FIG. 1, the process begins by processing logic building a Finite State Machine (FSM) model of the observed events which were observed during execution of the application (processing block 101). The model is used as the coverage criterion. In one embodiment, the observed events comprise system calls. In one embodiment, a state in the FSM model represents a program counter value of a system call in the test case and a transition in the FSM model represents the system call.

Next, processing logic executes an application with test inputs of a test case while performing software application testing (processing block 102).

Using the coverage criterion based on observed events from execution of other test cases in a test suite, processing logic determines whether to add the test case to the test suite for use in future testing of the application (processing block 103).

If the test case is to be added, processing logic updates the FSM model to include at least one additional transition or state if the at least one additional transition or state were not previously in the FSM model (processing block 104). If processing logic identifies the test case as redundant (where behavior of the text case has been observed previously as indicated by the coverage criteria), processing logic removes the test case from the test suite (processing block 105).

Next, processing logic determines if there are any more test cases to check (processing block 106). If there are, the process transitions to processing block 102 where the process is repeated. If not, the process ends.

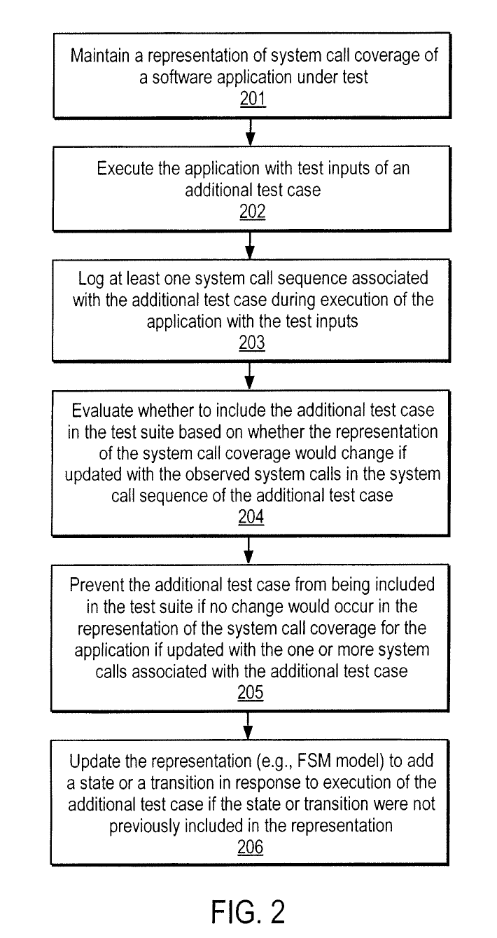

FIG. 2 is a flow diagram of another embodiment of a test suite reduction process. The process is performed by processing logic that may comprise hardware (circuitry, dedicated logic, etc.), software (such as is run on a general purpose computer system or a dedicated machine), or a combination of both.

Referring to FIG. 2, the process begins by processing logic maintaining a representation of system call coverage of a software application under test (processing block 201). The representation is generated based on one or more system call traces from a set of one or more test cases in a test suite executed on the application. In one embodiment, the representation comprises a model of the application built by observing system call sequences that occurred during execution of test cases in the test suite. In one embodiment, the model comprises a Finite State Machine (FSM) model. In one embodiment, the system call sequence captures an input/output (I/O) characteristic of the application.

While maintaining the representation (e.g., the FSM model), processing logic executes the application with test inputs of an additional test case (processing block 202) and logs at least one system call sequence associated with the additional test case during execution of the application with the test inputs (processing block 203). The system call sequence has one or more system calls.

After logging system call sequence(s), processing logic evaluates whether to include the additional test case in the test suite based on whether the representation of the system call coverage would change if updated with the observed system calls in the system call sequence of the additional test case that has been executed (processing block 204).

In one instance, processing logic prevents the additional test case from being included in the test suite if no change would occur in the representation of the system call coverage for the application if updated with the one or more system calls associated with the additional test case (processing block 205).

In another instance, processing logic updates the representation (e.g., FSM model) to add a state or a transition in response to execution of the additional test case if the state or transition were not previously included in the representation (processing block 206).

### An Example

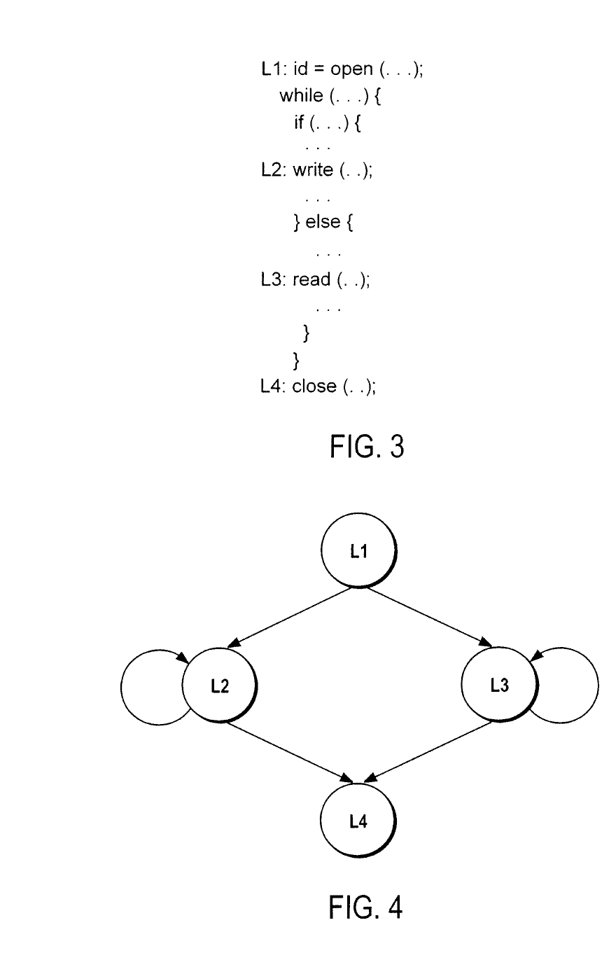

The techniques may be illustrated with the use of an example. FIG. 3 illustrates a code snippet. Referring to FIG. 3, the code snippet makes an open system call at L1 and it either reads from or writes to the file in a loop and finally closes it at L4.

When performing software testing on the code snippet, a finite state machine (FSM) model construction algorithm is employed to construct the FSM model. In one embodiment, the FSM model construction algorithm is the one described in Sekar, et al., “A Fast Automaton-based Method for Detecting Anomalous Program Behaviours, Proceedings of the 2001 IEEE Symposium on Security and Privacy, 2001, pg. 144-155, which is incorporated herein by reference. The FSM model construction algorithm constructs the FSM from system call traces observed during program execution. In such a case, the program counter is used as a state for the FSM and system calls are used as transitions for the FSM.

In one embodiment, the construction algorithm itself is fairly straightforward. The system performing the testing stops the program at every system call and uses a construct FSM procedure described below for building the FSM. In one embodiment, this procedure takes in the program counter value when the system call is made along with the system call number. For purposes herein, previous_pc is a global variable that holds previous state (program counter value) in which the FSM was in and the AddTransition(pc1, pc2, syscall) procedure adds a transition from pc1 to pc2 with syscall as the transition to the FSM.

```
previous_pc = 0; /* init state */
ConstructFSM(unsigned ProgramCounter, unsigned SysCall) {
    AddTransition(previous_pc, ProgramCounter, SysCall);
    previous_pc = ProgramCounter;
}
```

To illustrate the FSM construction algorithm operating, consider a test suite consisting of four test cases for the running example. Assume the system calls generated for the four test cases for this code snippet are as shown in the table below. The first test case, Test1, opens the file, reads twice from it (because of the loop), and then closes it. Test2, opens a file, writes twice to it and then closes the file. Test3, opens a file, reads three times from it and then closes it. Test4, opens a file, read's 4 times from it and then closes it.

| Test case | System call trace |
|---|---|
| Test1 | open, read, read, close |
| Test2 | open, write, write, close |
| Test3 | open, read, read, close |
| Test4 | open, read, read, read, close |

For the first test case, observe that it makes open at L1 program point, read at L2 program points (twice) and then makes close system call at L4. The FSM that is constructed by the software testing system by observing the system call traces and the program counter values is embedded in FIG. 4. From Test2, the existing FSM is updated by adding new transitions, from L1 to L3, L3 to L4 and L3 to itself. Thus, by using test cases test1 and test2, the complete FSM as shown in FIG. 4 can be obtained. Note that test cases test3 and test4 do not produce any new transitions in the FSM.

In one embodiment, the test suite reduction algorithm is an extension of the FSM construction algorithm described above. In order to perform test suite reduction, a current FSM that was built using previous test cases is maintained. In one embodiment, the current FSM may be stored in memory and accessible by the software testing system. For each new test case, the program is run on the test input associated with the new test case and an update to the FSM is attempted. If there are no updates to the FSM (i.e., no new transitions or states are added), then the test case is marked as redundant. This description may be summarized as the following steps:

```
CurrentFSM := φ
For each test case in the test suite,
  run the program on the test input;
  update the current FSM using FSM construction algorithm; and
  if there are no updates, mark the test case as redundant.
```

In case of the example above, assuming that the test suite had test cases test1, test2, test3 and test4 in that order, then test cases test3 and test4 are marked as redundant since they do not make any updates to the FSM as shown in FIG. 4.

The test suite reduction algorithm described thus far is only one embodiment and exhibits a bias towards test cases that are analyzed first in the test suite. In one embodiment, the bias towards first test suites is eliminated by randomly choosing test cases from a test suite. Obtaining a more optimal set of test cases that can cover the generated test suites is an NP complete problem.

In one embodiment, the reduction algorithm is implemented in Linux (Ubuntu, Kernel 2.6) and the etrace package is used for system call interception. For more information on the etrace package, see Jain & Seker, “User-level Infrastructure for System Call Interposition: A Platform for Intrusion Detection and Confinement,” in ISOC Network and Distributed System Security, 1999, pp 19-34. The etrace package uses a ptrace mechanism for system call interception and stops the program after every system call. This allows information on the type of the system call and the program counter value to be gathered. This type of system call interception/interposition is called user level system call interposition since the interposition is occurring at the user level by a different process. In another embodiment, interposition is performed at the kernel level using kernel level modules. This may be implemented using the techniques described in Fraser, et al., “Hardening COTS Software with Generic Software Wrappers,” IEEE Sym. on Security and Privacy, 1999, pp. 2-16. While the kernel option has less run-time overhead because there are no context switches, the user level system call interposition is easier to implement and debug.

In other embodiment, operating systems like Windows, MacOS, BSD all have system call (or equivalents) that can be used. System call interception tools/mechanisms for all of these operating systems are well-known and available.

Programs almost always make system calls from libraries (e.g., the Standard C library, etc.). If the program counter value is used at the time of system call as the state in the FSM, then the FSM would represent the behavior of the library instead of the program. To solve this problem, first, the list of possible addresses for program text is noted by statically analyzing the binary. After intercepting any system call, the return address on top of the stack is examined to see if it belongs to the recorded program text. If the return address is not in the recorded program text, then the stack frame is traversed to find the return address of the caller of the current function. This process is repeated this until a return address is hit that belongs to the program text and it is used as the program counter in the FSM.

As set forth above, in one embodiment, data values are not taken into account. This might mean that some computation faults are not captured by the reduced test suite. By increasing the accuracy of the system call model that takes into account at least some data values like system call arguments and system call return values, the reduced suite might be able to capture more computation faults. In one embodiment, such context information is used in the test suite reduction process. In one embodiment, context information is used in the FSM model in the same way system calls have been included in the context of intrusion detection building (e.g., Push down automatons as set forth in Feng, et al., Anomaly Detection Using Call Stack Information, 2003, dataflow as set forth in Bhathar, et al., Dataflow Anomaly Detection, in IEEE Sym. on Security and Privacy, Oakland, Calif., May 2006). Thus, in one embodiment, the FSM model is extended to capture any of these more accurate models and achieve better test suite reduction.

### One Embodiment of a Testing Environment

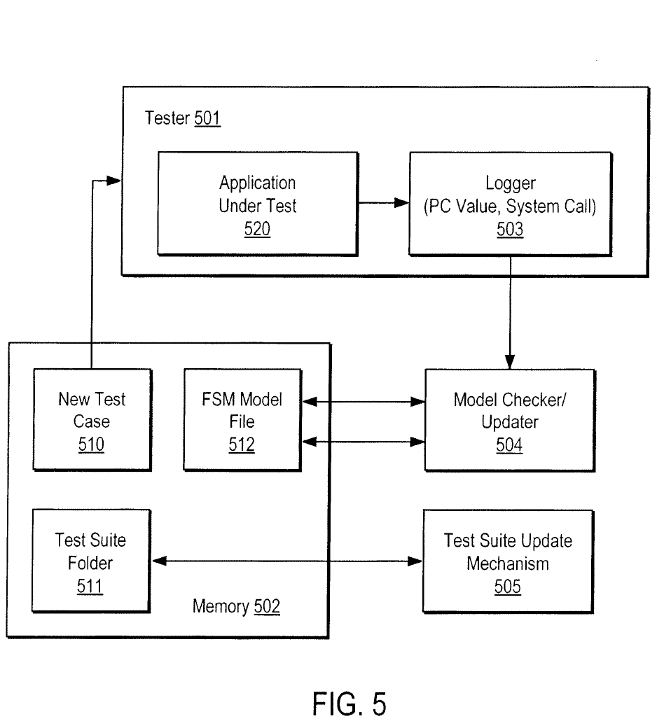

FIG. 5 is a block diagram of one embodiment of a testing environment. Referring to FIG. 5, a tester 501 is shown coupled to memory 502. Tester 501 executes the application 520 being software tested using a new test case 510 stored in memory 502. Memory 502 also stores test suite folder 511 that stores the test suite and FSM model 512. Note that new test case 510 may be one of the tests in test suit folder 511. Note also that although only one memory is shown, memory 502 may represent more than one memory.

While tester 501 tests application 520 using test inputs from new test case 510, system call logger 503 logs externally observable events into memory. The memory may be part of logger 503 or a memory external to logger 503 (e.g., memory 502). In one embodiment, the externally observable events comprise system calls and logger 503 logs the program counter value associated with the system call and the system call itself.

Model checker/updater 504 access memory 502 to obtain FSM model file 512 and attempts to update FSM model file 512 based on the logged information from execution of the application 520 using new test case 510. If model update/checker 504 determines that no update to FSM model file 512 would occur with the externally observed event information logged by logger 503, then model update/checker 504 signals test state update mechanism 505 which prevents new test case 510 from being included in the test suite 511. In such a case, in one embodiment, test state update mechanism 505 causes new test case 510 not to be added to the test suite stored in test suite folder 511. In another embodiment, in such a case, test state update mechanism 505 causes new test case 510 to be eliminated from the test suite stored in test suite folder 511.

If model update/checker 504 determines that an update to FSM model file 512 would occur with the externally observed event information logged by logger 503 (e.g., the logged information shows a new state or new transition would be added to FSM model file 512), then model update/checker 504 signals this to test state update mechanism 505. In such a case, in one embodiment, test state update mechanism 505 causes new test case 510 to be added to the test suite stored in test suite folder 511. In another embodiment, in such a case, test state update mechanism 505 causes new test case 510 to remain in the test suite stored in test suite folder 511. Also in such a case, model update/checker 504 updates FSM model file 512 and stores the updated version of FSM model file 512 back in memory 502.

### An Example of a Computer System

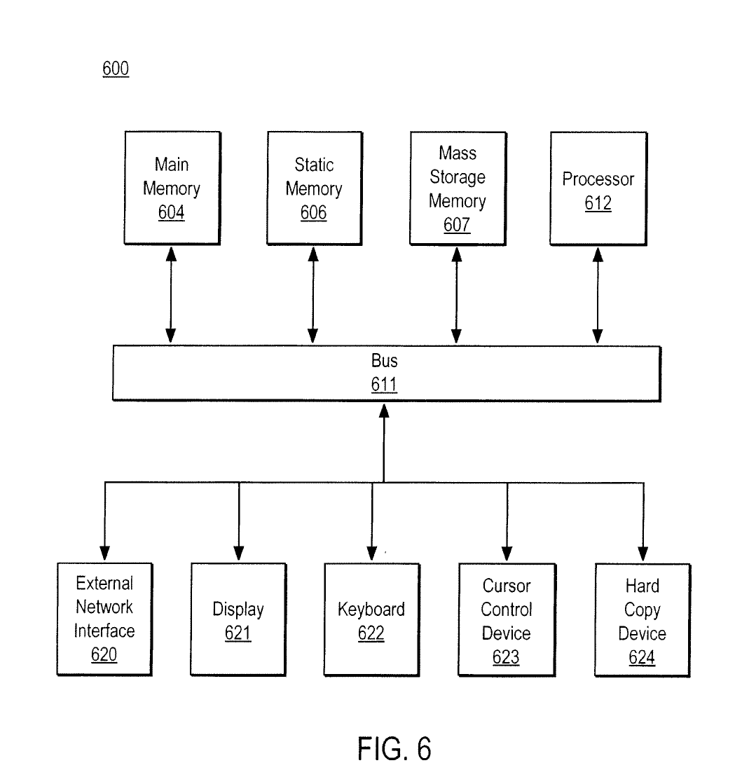

FIG. 6 is a block diagram of an exemplary computer system that may perform one or more of the operations described herein. Referring to FIG. 6, computer system 600 may comprise an exemplary client or server computer system. Computer system 600 comprises a communication mechanism or bus 611 for communicating information, and a processor 612 coupled with bus 611 for processing information. Processor 612 includes a microprocessor, but is not limited to a microprocessor, such as, for example, Pentium™, PowerPC™, Alpha™, etc. System 600 further comprises a random access memory (RAM), or other dynamic storage device 604 (referred to as main memory) coupled to bus 611 for storing information and instructions to be executed by processor 612. Main memory 604 also may be used for storing temporary variables or other intermediate information during execution of instructions by processor 612.

Computer system 600 also comprises a read only memory (ROM) and/or other static storage device 606 coupled to bus 611 for storing static information and instructions for processor 612, and a data storage device 607, such as a magnetic disk or optical disk and its corresponding disk drive. Data storage device 607 is coupled to bus 611 for storing information and instructions.

Computer system 600 may further be coupled to a display device 621, such as a cathode ray tube (CRT) or liquid crystal display (LCD), coupled to bus 611 for displaying information to a computer user. An alphanumeric input device 622, including alphanumeric and other keys, may also be coupled to bus 611 for communicating information and command selections to processor 612. An additional user input device is cursor control 623, such as a mouse, trackball, trackpad, stylus, or cursor direction keys, coupled to bus 611 for communicating direction information and command selections to processor 612, and for controlling cursor movement on display 621.

Another device that may be coupled to bus 611 is hard copy device 624, which may be used for marking information on a medium such as paper, film, or similar types of media. Another device that may be coupled to bus 611 is a wired/wireless communication capability 625 to communication to a phone or handheld palm device.

Note that any or all of the components of system 600 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
executing an application with test inputs of a test case during performance of software application testing; and
using a Finite State Machine (FSM) model of observable events generated from execution of other test cases in a test suite to determine whether to include the test case to the test suite for use in future testing of the application.

2. The method defined in claim 1 wherein the observable events comprise system calls.

3. The method defined in claim 1 further comprising building the FSM model of the observable events which were observed during execution of the application, the model being used as coverage criterion.

4. The method defined in claim 3 wherein the observable events comprise system calls.

5. The method defined in claim 1 further comprising updating the FSM model to add a transition or state in response to execution of the test case if the transition or state were not previously in the FSM model.

6. The method defined in claim 5 wherein a state in the FSM model represents a program counter value of a system call in the test case and a transition in the FSM model represents the system call.

7. The method defined in claim 1 further comprising identifying the test case as redundant if behavior of the test case has been observed previously as indicated by the coverage criteria and removing the test case from the test suite.

8. A method comprising:
maintaining a model of system call coverage of a software application under test, the model generated based on observation of system call sequences that occurred during execution of one or more test cases in a test suite executed on the application;
executing the application with test inputs of an additional test case; and
evaluating inclusion of the additional test case in the test suite based on whether the model of the system call coverage would change if updated with the one or more system calls in the system call sequence of the additional test case that were observed during execution of the additional test case.

9. The method defined in claim 8 further comprising preventing the additional test case from being included in the test suite if no change would occur in the representation of the system call coverage for the application if updated with the one or more system calls associated with the additional test case.

10. The method defined in claim 8 wherein the model comprises a Finite State Machine (FSM) model.

11. The method defined in claim 10 further comprising updating the FSM model to add a state or a transition in response to execution of the additional test case if the state or transition were not previously included in the FSM model.

12. The method defined in claim 8 wherein the system call sequence captures an input/output (I/O) characteristic of the application.

13. The method defined in claim 8 further comprising logging a system call sequence associated with the additional test case during execution of the application with the test inputs, the system call sequence having one or more system calls.

14. An article of manufacture having one or more computer-readable storage media storing instructions which, when executed by a system, cause the system to perform a method comprising:
executing an application with test inputs of a test case during performance of software application testing; and
using a Finite State Machine (FSM) model of observable events generated from execution of other test cases in a test suite, to determine whether to add the test case to the test suite for use in future testing of the application.

15. The article of manufacture defined in claim 14 wherein the observable events comprise system calls.

16. The article of manufacture defined in claim 15 wherein the method further comprises building the FSM model of the observable events which were observed during execution of the application, wherein the observed events comprise system calls.

17. The article of manufacture defined in claim 14 wherein the method further comprises updating the FSM model to include a transition or state in response to execution of the additional test case if the transition or state were not previously in the FSM model.

18. The article of manufacture defined in claim 17 wherein a state in the FSM model represents a program counter value of a system call in the test case and a transition in the FSM model represents the system call.

19. The article of manufacture defined in claim 15 wherein the method further comprises identifying the test case as redundant if behavior of the test case has been observed previously as indicated by the coverage criteria and removing the test case from the test suite.
